(19) United States
(12) Patent Application Publication
(10) Pub. No.: US 2025/0213892 A1
(43) Pub. Date: Jul. 3, 2025

(54) VEHICLE EQUIPPED WITH A DEVICE FOR ASSISTANCE IN EMERGENCY EVACUATION, LIQUID RETENTION DEVICE EQUIPPED WITH SUCH A DEVICE FOR ASSISTANCE IN EVACUATION, AND DEVICE FOR ASSISTANCE IN EMERGENCY EVACUATION

(71) Applicant: Antar DAOUK, PARIS (FR)

(72) Inventor: Antar DAOUK, PARIS (FR)

(21) Appl. No.: 18/847,880

(22) PCT Filed: Mar. 18, 2023
(86) PCT No.: PCT/FR2023/050384

§ 371 Date: Sep. 17, 2024

(30) Foreign Application Priority Data
Mar. 18, 2022 (FR) FR2202433

(51) Int. Cl. A62B 3/00; B60N 3/02; B60R 3/00; B60R 3/02; B63B 43/00; B64D 25/08; E05B 63/22; E05C 3/04

(52) U.S. Cl. CPC A62B 3/00; B60N 3/023; B60R 3/007; B60R 3/02; B63B 43/00; B64D 25/08; E05B 63/22; E05C 3/042; B63B 2043/006

(57) ABSTRACT

A vehicle comprising an inner wall (5), an evacuation exit of the vehicle, and a device (1) for assisting the emergency evacuation of the vehicle secured to said wall (5) by means of a fastening means (3, 4), said device (1) comprising a case (2) with a main body (20) delimiting an inner volume (V), and also a cover (7) connected to the main body (20) by a permanent connection means (8), said main body (20), fastening member (3, 4), cover (7) and permanent connection means (8) being shaped and dimensioned such that the cover (7) contributes to forming, in the open position, a bearing area and/or a grip allowing a person to hoist themselves towards the evacuation exit.

### TECHNICAL FIELD

The present invention concerns the general technical field of equipment for assisting the survival and evacuation of persons in danger in closed cabin vehicles, in particular aircraft or marine and underwater vehicles, and also falls within the general field of equipment intended to be fastened to the walls of such vehicles.

The present invention concerns more precisely a vehicle comprising an interior wall, which forms for example an interior wall of cabin or cockpit, as well as an evacuation exit of the vehicle.

The present invention also concerns as such a liquid retention device fitted to such a vehicle.

Finally, the present invention also concerns as such a device for assisting the emergency evacuation of a vehicle.

### PRIOR ART

The closed cabin vehicles can, in the event of an accident, trap their occupants and thus put their lives in danger. This risk is particularly significant with regard to aircraft, such as helicopters. Thus, if a helicopter accidentally hits the ground or a body of water and falls on its side, its passengers could experience great difficulty in reaching the lateral emergency exits still in the open air, which end up overhanging the passengers. The latter must therefore climb inside the cabin to try to reach the emergency exit, which can prove particularly difficult, especially in the moments immediately following the crash of the apparatus on the ground or in the water. This problem primarily concerns the helicopters dedicated to rescue missions whose cabin is generally cluttered with abundant and bulky equipment likely to hinder the evacuation of the passengers if the helicopter goes down on the side. In particular, the helicopters dedicated to the recovery of individuals in the open sea can be equipped with a water retention tray disposed on the floor of their cabin to collect the sea water flowing from the stretcher after a person to be picked up at sea being hoisted by helicopter for example. The presence of such a retention tray, which covers the floor, does not facilitate evacuation of the cabin in an emergency situation such as that mentioned above.

Of course, the problem disclosed in the above does not only concern the helicopters and also concerns planes or even marine or underwater vehicles, and in general all closed vehicles within which passengers can be confined.

### DISCLOSURE OF THE INVENTION

The objects assigned to the present invention therefore aim to remedy the different drawbacks listed above and to propose a new vehicle which, in the event of an accident, provides its passengers with the possibility of effective, compact, lightweight and easily integrated assistance (including in a very constrained environment such as the cabin of a rescue helicopter), to allow passengers to extract themselves from said vehicle by their own means, particularly in the event of immobilization of the latter in an inclined orientation relative to the normal operation orientation.

Another object of the invention aims to propose a new vehicle which, while being particularly safe in the event of an accident, is of particularly simple and robust construction.

Another object of the invention aims to propose a new vehicle providing emergency evacuation assistance whose implementation is secure.

Another object of the invention aims to propose a new vehicle which implements a minimum of components and provides particularly intuitive and ergonomic emergency evacuation assistance.

Another object of the invention aims to propose a new vehicle which does not require positive action by the user to facilitate emergency evacuation in the event of an accident.

Another object of the invention aims to propose a new vehicle which does not require electrical power to facilitate emergency evacuation in the event of an accident.

Another object of the invention aims to propose a new vehicle which, while providing particularly practical travel assistance in the event of an emergency, has an optimized habitable interior volume.

Another object of the invention aims to propose a new vehicle which allows easy access to functionalities and/or emergency or evacuation equipment.

Another object of the invention also aims to propose a new liquid retention device intended to be embedded on the interior floor of a vehicle and which makes it possible to facilitate the evacuation of said vehicle in the event of an emergency, including when the vehicle stops in an inclined orientation relative to the normal operation orientation.

Another object of the invention aims to propose a new device for assisting the emergency evacuation of a vehicle which, while providing the passengers of an accident vehicle with the possibility of effective assistance to enable the latter to extract themselves from said vehicle by their own means, is of particularly compact, light and easily integrated construction, including in a very constrained environment such as the cabin of a rescue helicopter.

Another object of the invention aims to propose a new device for assisting the emergency evacuation of a vehicle which has a universal character and can be used to secure any type of vehicle.

Another object of the invention aims to propose a new device for assisting the emergency evacuation of a vehicle, which is of particularly simple and robust construction.

Another object of the invention aims to propose a new device for assisting the emergency evacuation of a vehicle, the use of which is safe.

Another object of the invention aims to propose a device for assisting the emergency evacuation of a vehicle, which implements a minimum of components and is particularly intuitive and ergonomic.

Another object of the invention aims to propose a new device for assisting the emergency evacuation of a vehicle which does not require positive action by the user to be able to be used in the event of an emergency.

Another object of the invention aims to propose a new device for assisting the emergency evacuation of a vehicle which does not require an electrical power.

Another object of the invention aims to propose a new device for assisting the emergency evacuation of a vehicle which, while having a particularly space-saving and discreet geometry, provides particularly practical travel assistance in the event of an emergency.

Another object of the invention aims to propose a new device for assisting the emergency evacuation of a vehicle which allows very easy access to functionalities and/or emergency or evacuation equipment.

The objects assigned to the present invention are achieved using a vehicle comprising:
an interior wall, which forms for example an interior wall of cabin or cockpit,
an evacuation exit of the vehicle,
and a device for assisting the emergency evacuation of the vehicle which is secured to said wall by means of at least one fastening member, said device comprising a case, said case comprising a main body delimiting an interior volume as well as at least one cover connected to said main body by permanent connection means which allows the cover to move relative to said main body between a closed position in which said cover closes access to said interior volume and an open position in which said cover frees access to said interior volume while projecting from said main body, said main body, fastening member, cover and permanent connection means being shaped and dimensioned so that the cover contributes to forming, in the open position, a bearing area and/or a grip allowing a person to hoist themselves towards said evacuation exit by leaning on, and/or grabbing, said cover.

The objects assigned to the present invention are also achieved using a liquid retention device intended to be embedded on the interior floor of a vehicle according to the invention, said liquid retention device being designed and configured to collect equipment embedded in said vehicle, for example a seat or a stretcher, the retention device comprising at least:
an upper wall designed and configured to support said equipment, said upper wall being provided with a plurality of through holes,
a liquid storage tank arranged at least partly below said upper wall to collect liquid passing through said through holes,
a housing provided in said upper wall,
said case being disposed within said housing.

The objects assigned to the present invention are finally achieved using a device for assisting the emergency evacuation of a vehicle comprising a case provided with at least one fastening member for reversibly securing said case to a wall of said vehicle, said case comprising a main body delimiting an interior volume as well as at least one cover connected to said main body by a permanent connection means which allows the cover to move relative to said main body between a closed position in which said cover closes access to said interior volume and an open position in which said cover frees access to said interior volume while projecting from said main body, said main body, fastening member, cover and permanent connection means being shaped and dimensioned so that the cover contributes to forming, in the open position, a bearing area and/or a grip allowing a person to hoist themselves towards an evacuation exit of the vehicle by leaning on, and/or in grabbing, said cover, said device including, disposed in said interior volume, one or more of the following devices: a flexible unwindable ladder, a handle stationary or articulated to the main body, a hook, a ring, a respirator mask, a supplementary respiratory block.

Other objects and advantages of the invention will emerge in more detail on reading the description which follows, and with the aid of the appended figures provided for purely explanatory and non-limiting purposes, in which:

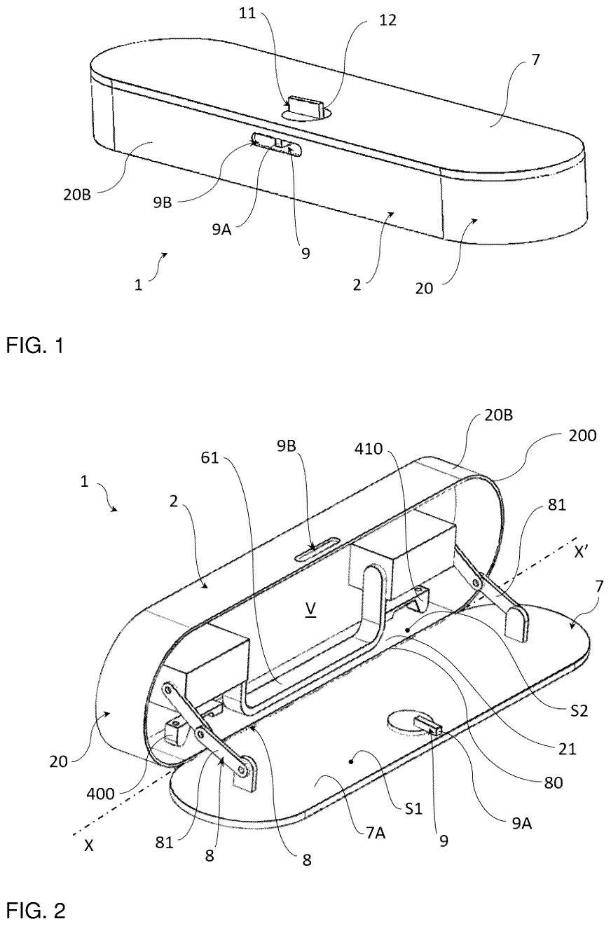

FIG. 1 illustrates, schematically in a perspective view, a device for assisting the emergency evacuation of a vehicle according to a first embodiment of the invention, with its cover in the closed position.

FIG. 2 illustrates, in a schematic perspective view, the emergency evacuation assistance device of FIG. 1, the cover of which is this time in the open position, said device including a pivoting handle disposed within its interior volume.

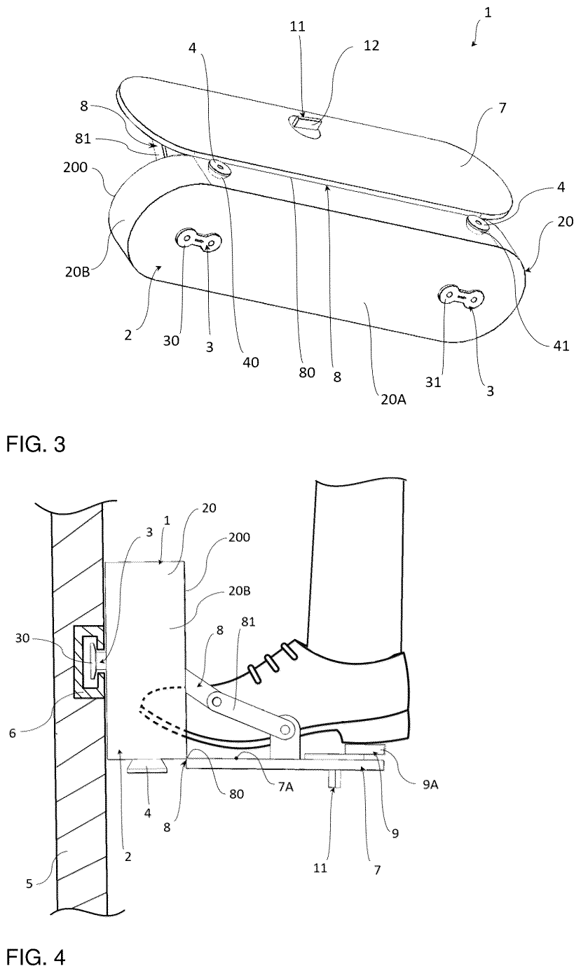

FIG. 3 illustrates the emergency evacuation assistance device of FIG. 2, with its cover open, in a bottom perspective view.

FIG. 4 illustrates, in a partial cross-sectional side view, the emergency evacuation assistance device of the preceding figures secured to a fastening rail integrated into a wall of the cabin of a vehicle, the cover of which in the open position is used as a step by a user to hoist themselves towards an emergency exit of said vehicle.

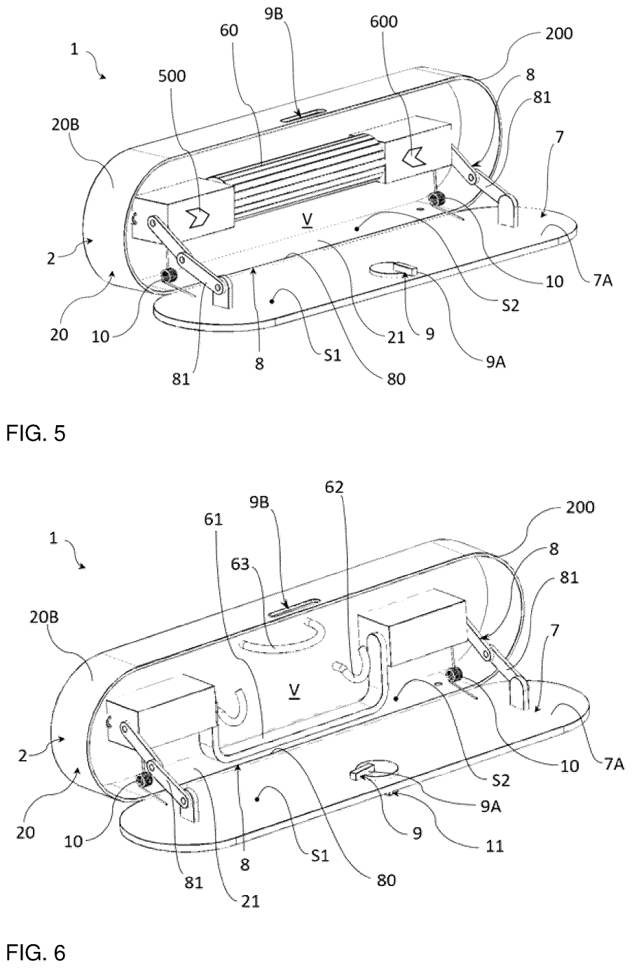

FIG. 5 illustrates, in a schematic perspective view, a device for assisting the emergency evacuation of a vehicle conforming to a second embodiment, the cover of which is in the open position, said second embodiment being distinct from the first embodiment of the preceding figures essentially by the fact on the one hand that it embeds, within its interior volume, not a pivoting handle but a flexible unwindable ladder, and on the other hand that it implements return springs to return the cover to the open position.

FIG. 6 illustrates, in a schematic perspective view, a third embodiment of a device for assisting the emergency evacuation of a vehicle, with its cover in the open position, said device being distinct from the second embodiment of FIG. 5 by the fact that instead of the flexible unwindable ladder, a pivoting handle, hooks and a ring are housed within the interior volume.

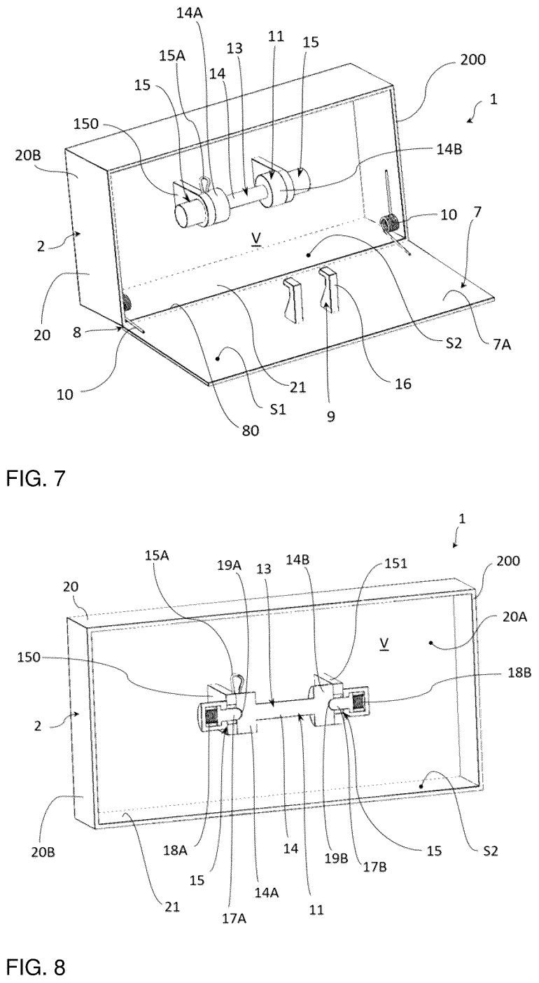

FIG. 7 illustrates, in a schematic perspective view, a fourth embodiment of an emergency evacuation assistance device according to the invention, the cover of which is open, and which is provided with a lock and a member for controlling the lock which comprises a shock-sensitive element.

FIG. 8 illustrates, in a schematic longitudinal-sectional view, the emergency evacuation assistance device of FIG. 7.

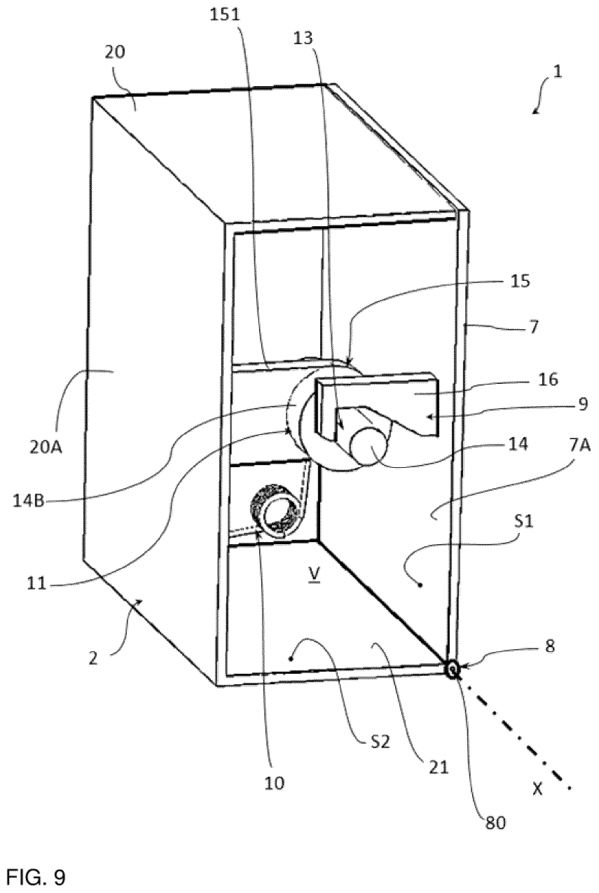

FIG. 9 illustrates, in a schematic cross-sectional view, the emergency evacuation assistance device of FIGS. 7 and 8, the cover of which is locked in the closed position.

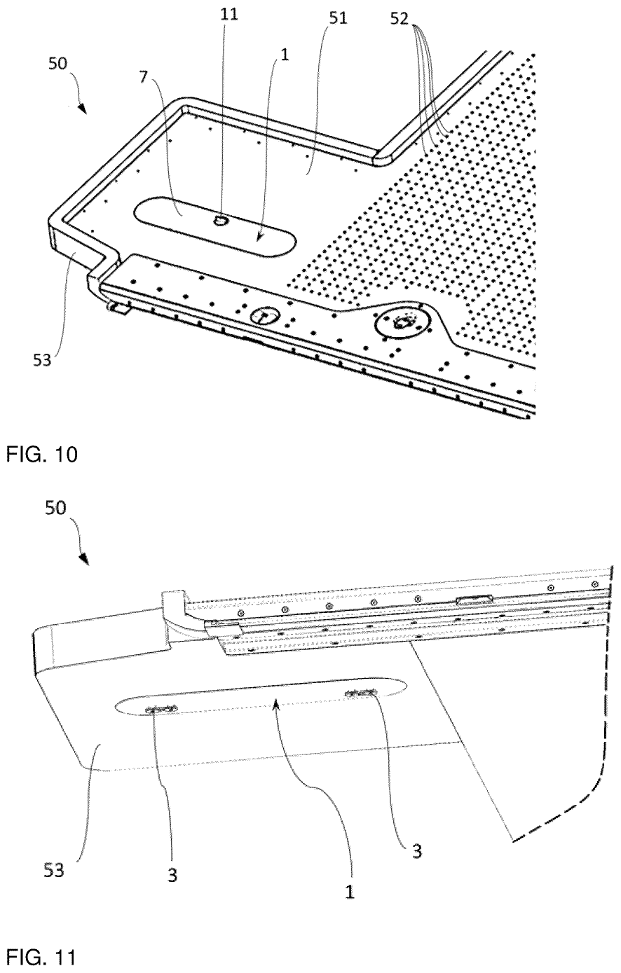

FIG. 10 illustrates, in a top partial schematic perspective view, a liquid retention device according to the invention, which incorporates a device for assisting the emergency evacuation of a vehicle according to the invention.

FIG. 11 illustrates, in a bottom partial schematic perspective view, the liquid retention device of FIG. 10.

### BEST WAY TO CARRY OUT THE INVENTION

The following description applies equally to the vehicle, to the liquid retention device and to the device for assisting the emergency evacuation of a vehicle according to the invention.

The invention concerns, according to a first aspect, a device 1 for assisting the emergency evacuation of a vehicle, in particular for assisting the evacuation of an accident vehicle, intended to enable people on board the vehicle, for example within a closed cabin of the latter, to extract themselves from the vehicle by their own means, particularly in the event of an emergency following for example an accident. The device 1 thus facilitates the evacuation of people from the vehicle concerned, including and especially when said vehicle has accidentally stopped in a position and/or orientation not corresponding to the position and/or orientation of normal operation. In such an abnormal configuration, the vehicle rests for example on one of its sides, so that the floor of its cabin is for example vertical instead of horizontal. The emergency evacuation assistance device 1 according to the invention thus makes it possible, even in this type of catastrophic configuration, to help the survival and evacuation of people in danger inside the vehicle, by providing them with bearing or hanging points facilitating the displacement in the direction of an emergency exit, as will be described in more detail below.

The invention also concerns as such a vehicle equipped with such an emergency evacuation assistance device 1. Said vehicle comprises an interior wall 5, which forms for example an interior wall of cabin or cockpit, said wall 5 thus being located inside the vehicle, for example in the cabin or cockpit of the latter, inside of the control cabin if it is an aircraft (plane or helicopter). The vehicle according to the invention also comprises at least one evacuation exit of the vehicle, which is for example in the form of an opening (provided or not with a door, a porthole or a closing window) to allow any person housed in the vehicle (inside the control cabin for example) to escape out of the vehicle, if necessary by opening a door or breaking a window.

The emergency evacuation assistance device 1 according to the invention advantageously has a universal design which makes it suitable for equipping all types of vehicles, of whatever nature. For example, the vehicle according to the invention can be a land vehicle, a marine vehicle or an air vehicle. Preferably, said vehicle is part of at least one of the following groups:
flying vehicles, including aerostats and aerodynes with stationary (e.g. airplanes) or rotating (e.g. helicopters) wings,
marine or underwater vehicles.

In what follows, reference will be made to an emergency evacuation assistance device 1 intended to equip a helicopter, for example a rescue or evacuation helicopter, it being understood that the invention is in no way limited to this preferential application and may concern, as already mentioned above, any other vehicle, and in particular vehicles delimiting a confined interior space.

As illustrated in the figures, the device 1 comprises a case 2 which has for example a substantially oblong (FIGS. 1 to 6) or parallelepiped (FIGS. 7 to 9) shape. The case 2 thus forms a volume element, which defines a useful interior space and presents an evolving geometry allowing it, depending on the circumstances, to adopt a reduced bulk configuration when the vehicle is in normal operation, while being able to adopt, in the event of an accident, an emergency evacuation assistance configuration. Said case 2 is advantageously made of a rigid material, such as for example a metallic material (steel or aluminum for example). However, the use of a plastic or composite material can be considered. As illustrated in the figures, the case 2 advantageously comprises a main body 20 delimiting an interior volume V. For example, the main body 20 comprises a bottom 20A as well as a lateral wall 20B which rises from said bottom 20A, for example at the periphery of the latter, between a lower edge secured to said bottom 20A and a free upper edge 200. Said free upper edge 200 defines an opening providing access to the interior volume V.

Said case 2 is provided with at least one fastening member 3, 4 for securing, preferably reversibly, the case 2 to a wall 5 of said vehicle. As mentioned previously, said wall 5 of the vehicle is an interior wall of the vehicle, which forms for example an interior wall of cabin or cockpit. This means that the wall 5 is included in an internal volume of the vehicle, so that it is not directly exposed to the external environment and is protected at least from rain, unlike an exterior wall, that is to say a wall (for example of a fuselage) which is directly exposed to the external environment (air or water for example) of the vehicle. Advantageously, the fastening member 3, 4 is secured to the main body 20, that is to say it is embedded in said main body 20 and advantageously projects from the main body 20, towards the outside of the latter. The fastening member 3, 4 projects for example from the bottom 20A and/or from the lateral wall 20B, as illustrated in the figures.

Said wall 5 advantageously constitutes the interior floor of the vehicle, for example the interior floor of the cabin of a helicopter. However, it is perfectly possible to secure the case 2 to an interior wall of the vehicle other than the floor. The fastening member 3, 4 preferably ensures reversible securing of the case 2 to the wall 5, that is to say that the case 2 can be easily and at will detached from, and attached to, said wall 5, preferably without the need to use tools. The fastening member 3, 4 therefore advantageously constitutes a rapid fastening system, without tools, which allows removable fastening of the case 2 to the wall 5. Thanks to this reversible nature, the emergency evacuation assisting device 1 according to the invention can be easily installed and uninstalled, depending for example on the usage constraints of the vehicle concerned and the equipment possibly embedded in the latter. In the case of a helicopter or another aircraft, the interior arrangement of the cabin and/or cockpit can change depending, for example, on the use assigned to the vehicle and the missions to be fulfilled. The reversible securing provided by the fastening member 3, 4 makes it possible to place or move the case 2 to an appropriate location, to take into account the bulk and the placement of other equipment required within the cabin.

For example, as illustrated in FIG. 4, the fastening member 3 is intended to cooperate with an aeronautical rail 6 which is for example recessed in the wall 5. Such aeronautical rails are well known as such and are for example intended to receive aircraft seat anchors. In this embodiment, the fastening member 3 comprises at least one foot 30, and preferably two feet 30, 31 intended to cooperate with an aeronautical rail 6 of combined shape. Each foot 30, 31 comprises for example one or more enlarged head(s) intended to be inserted into corresponding cells provided on the surface of the rail 6. Each cell of the rail 6 is separated from the adjacent cells by an inter-cell portion of reduced section. It is then sufficient to offset longitudinally, along the rail 6, the feet 30, 31 to capture the enlarged heads of the latter by an inter-cell portion of reduced section. Said longitudinal offset of the feet 30, 31 to capture their enlarged heads by inter-cell portions of the rail 6 is obtained by translation of the feet 30, 31 along the stationary rail 6. For example, the feet 30, 31 are stationary relative to the main body 20, so that said translation of the feet 30, 31 is carried out by translation of the main body 20 relative to the rail 6. Alternatively, the feet 30, 31 are mounted movable in translation relative to the main body 20. The latter is therefore in this case placed facing the rail 6 in its fastening position, then the feet 30, 31 are moved in translation relative to the main body 20 and the rail 6 to thus offset the enlarged heads of the feet 30, 31 and the cells of the rail 6. Advantageously, the case 2 includes a means for manually controlling (not illustrated) the translational displacement of the feet 30, 31 relative to the main body 20. Preferably, for reasons of safety and reliability, said manual control means is housed inside the case 2, in the interior volume V, so that it is only accessible from the inside of the main body 20. Such a rapid reversible installation/uninstallation system is well known as such and therefore does not need to be described further here. However, the use of a rail 6 is not absolutely not obligatory, and it is for example possible that the fastening member 3 cooperates with localized bases, which do not have an elongated shape like that of the rails.

Alternatively, or in addition to the fastening member 3 described above, the case 2 is provided with a fastening member 4 capable of cooperating with a smooth surface, devoid of an aeronautical rail. In this case, the fastening member 4 comprises for example one or more suction cups 40, 41. Each suction cup 40, 41 comprises for example a flexible membrane associated with a control means 400, 410 (for example a lever) allowing depression of the interstitial space delimited by the wall 5 on the one hand and said flexible membrane on the other hand. Here again, the control means 400, 410 is advantageously housed inside the main body 20, in the interior volume V, so that it is only accessible from the inside of the main body 20.

The invention is of course not limited to a particular type of fastening member 3, 4, and other fastening members can be implemented, provided that they preferably ensure rigid securing of the case 2 to the wall 5, that is to say a securing substantially eliminating any degree of freedom between the case 2 and said wall 5.

The fastening member 3, 4 can be designed to secure the case 2 directly to the wall 5, as illustrated for example in FIG. 4, but it is alternatively possible that the fastening member 3, 4 reversibly secures the case 2 to other equipment which itself is secured (reversibly or not) to the wall 5. In this case, the fastening member 3, 4 is designed to secure the case 2 indirectly to the wall 5.

In accordance with the invention, the case 2 also comprises at least one cover 7 connected to said main body 20 by a permanent connection means 8 which allows the cover 7 to move relative to said main body 20 between a closed position (FIGS. 1 and 9) in which said cover 7 closes access to said interior volume V and an open position (FIGS. 2 to 8) in which said cover 7 frees access to said interior volume V while projecting from said main body 20. The permanent connection means 8 thus advantageously ensures the guiding of the cover 7 between its closed and open positions.

The cover 7 can be formed, as illustrated in the figures, by a single integral piece in the form of a plate whose shape is combined with that of the access opening defined by the upper edge 200. However, it is perfectly conceivable that the cover 7 is formed by different movable pieces that are independent of each other.

In accordance with the invention, said case 2, fastening member 3, 4, cover 7 and permanent connection means 8 are shaped and dimensioned so that the cover 7 contributes to forming, in the open position, a bearing area and/or a grip allowing a person to hoist themselves towards an evacuation exit of the vehicle by leaning on, and/or grabbing, said cover 7. In other words, the cover 7 provides a dual function, namely:
a first function of shutting off the access opening to close the interior volume V; and
a second bearing or grip function intended to support all or part of the weight of one or more people to help them move within the vehicle towards the emergency exit.

To this end, the fastening member 3, 4 must ensure sufficiently robust securing of the case 2 to the wall 5 to prevent any untimely detachment of the case 2 from the wall 5. This means that the fastening member 3, 4 must provide a fastening of the case 2 to the wall 5 which withstands a force corresponding at least to the weight of an individual, corrected if necessary by a safety coefficient. The minimum force to which the fastening provided by the fastening member 3, 4 must withstand is for example equal to 1000 N, preferably equal to 2000 N, even more preferably equal to 3000 N, preferably whatever the direction in which the minimum force in question (traction, shearing, twisting, etc.) is exerted. In the same way, the main body 2, to which is attached the fastening member 3, 4 on the one hand and the cover 7 on the other hand, must itself be sufficiently resistant not to break when a person leans on the cover 7 in the open position to hoist itself towards the evacuation exit. To this end, the main body 2 is advantageously made of metal (for example aluminum) with sufficient dimensions so as not to deform, deteriorate or break when a person leans on the cover 7 connected to the main body 20 of the case 2.

The cover 7 is of course also designed to withstand the forces involved when a person leans on it, or hangs on it, to hoist themselves towards the evacuation exit of the vehicle. The cover 7 is therefore advantageously made of a metallic material (for example aluminum) and has a sufficient thickness so as not to plastically deform or break when a person leans on the cover 7 to hoist themselves towards the evacuation exit.

Finally, the permanent connection means 8, which ensure the connection of the cover 7 to the main body 20, are also sufficiently robust to withstand the forces transmitted to them by the cover 7 when the latter is used as a bearing area and/or taken by an individual. The permanent connection means 8 are advantageously also made of metal (aluminum or steel for example), with sufficient dimensions to withstand the forces involved.

Advantageously, the cover 7 has at least one first surface S1, while the main body 20 has at least one second surface S2 located in said interior volume V. The first surface S1 is for example formed by the internal face 7A of the cover 7, which is intended to be located facing the internal volume V when the cover 7 is in the closed position. The second surface S2 is itself for example formed by a portion of the internal face 21 of the lateral wall 20B, said internal face 21 of the lateral wall 20B being located facing the interior volume V. Advantageously, said first surface S1 comes be positioned substantially in continuity with said second surface S2 when the cover 7 is in the open position, as illustrated in FIGS. 2, 5, 6 and 7. Thanks to this characteristic, the first and second surfaces S1, S2 combine to form a resulting larger bearing surface, and therefore easier, practical and comfortable to use, as illustrated for example in FIG. 4. In the situation of FIG. 4, an individual uses the cover 7 as a step in order to hoist himself up towards an evacuation exit of the vehicle, this step having a large surface since corresponding to the combination of the first and second surfaces S1, S2. Preferably, the space to the right of the first surface S1 and the second surface S2 is relatively clear, in order to allow the user to bear it and/or insert part of his body there, as illustrated for example in FIG. 4.

Advantageously, the cover 7 is articulated to the main body 20, so that the displacement of the cover 7 relative to the main body 20 is a rotational displacement, or at least includes a rotational component. Preferably, the permanent connection means 8 includes at least one hinge 80 connecting the main body 20 and cover 7, so that said cover 7 is pivotally mounted relative to the main body 20, along a pivot axis X-X′. For example, the hinge 80 is disposed at the upper edge 200 of the lateral wall 20B, and advantageously extends over a rectilinear portion of said upper edge 200.

Advantageously, the permanent connection means 8 includes at least one means 81 for maintaining said cover 7 in the open position. The maintaining means 81 may include for example one or more compasses, as illustrated in FIGS. 2 to 6, which allow, in combination with the hinge 80, to limit the angular movement of the cover 7 relative to the main body 20. For example, in the embodiment illustrated in the figures, the permanent connection means 8 includes, in addition to the hinge 80, two compasses 81 disposed on either side of the case 20 and which limit the angular movement of the cover 7 relative to the main body 20 at an angle of 90°. In other words, the cover 7 can pivot from its closed position, in which it forms an angle of 0° with the main body 20, to its open position in which it forms, as illustrated in the figures, an angle of 90° with the main body 20, which makes it possible to bring the first surface S1 in continuity with the second surface S2 as explained previously. The invention is of course not limited to an angular movement of 90°. Such an angular movement, however, proves to be particularly advantageous because it makes it possible to create a particularly practical bearing point in the situation where the vehicle is accidentally immobilized on its side, so that its floor, which in this case corresponds to the wall 5 to which the case 2 is fastened by its bottom 20A, is then vertical as illustrated in FIG. 4. In this case, the passage of the cover 7 in the open position, corresponding to an angular travel of 90°, allows the cover 7 to be positioned substantially horizontally, so that it can serve as a step or rung to climb towards an evacuation exit which extends for example perpendicular to the floor forming the wall 5.

The permanent connection means 8 includes for example a member for blocking the cover 7 in the open position, which acts on the maintaining means 81 to prevent the cover 7 to return to the closed position from its open position. Thanks to this advantageous characteristic, it is possible to rest not only on the interior face 7A of the cover 7, but also on its opposite exterior face, without the cover 7 folding into the closed position. For this, each compass advantageously forming the maintaining means 81 is for example provided with a system for relatively locking its arms, which automatically blocks the latter in relative position when the cover 7 reaches its open position.

As illustrated in the figures, the cover 7 is advantageously designed to:
in the closed position, extend in a first plane substantially perpendicular to the lateral wall 20B to shut off the access opening defined by the free upper edge 200, and
in the open position, extend in a second plane which is advantageously substantially perpendicular to said first plane.

Preferably, the first plane is substantially parallel to the wall 5, so that in the closed configuration the cover 7 does not constitute an obstacle likely to disturb the passengers of the vehicle. On the other hand, the second plane is advantageously perpendicular to the wall 5, so that in the open position the cover 7 advantageously projects to the right of said wall 5, perpendicular to the latter.

Thus, it turns out to be particularly advantageous to attach the main body 20 by its bottom 20A to the wall 5, with the pivot axis X-X′ of the cover 7 relative to the main body 20 disposed substantially parallel to said wall 5 to obtain, by pivoting the cover 7 from its closed position to its open position, a bearing area and/or a grip positioned and oriented appropriately. Of course, several emergency evacuation assistance devices 1 according to the invention may be provided and attached in different locations within the same vehicle, for example in different orientations taking into account the arrangement of each evacuation exit of the vehicle, to deal with all emergency situations which can be envisaged and which correspond for example to an accidental immobilization of the vehicle in different spatial orientations.

Advantageously, the case 2 is coupled to one or more of the following systems: signaling system, localization system, external distress systems,
so that the passage of the cover 7 out of its closed position is detected and in response controls the triggering of one or more actions by one or more of the aforementioned systems, such as for example:
   emission of a sound, light, radioelectric and/or pyrotechnic signal by the signaling system,
   emission by the localization system of a signal containing the instantaneous coordinates (for example GPS) of the vehicle,
   triggering of one or more external distress system(s) (for example release of a beacon or inflation of a buoyancy assistance device).

Advantageously, the case 2 comprises a lock 9 capable of alternately adopting an activated configuration, in which it is designed to maintain the cover 7 in the closed position, and a deactivated configuration, in which it is designed to allow the passage of the cover 7 in the open position. Preferably, the case 2 includes at least one elastic element 10 which exerts a force on the cover 7 for returning to the open position. Such an elastic element is illustrated in relation to the embodiments of FIGS. 5 to 9, but it can also be included in the other embodiments of FIGS. 1 to 4. In general, the different embodiments illustrated can be combined, so that features present in one embodiment can be implemented in another embodiment which lacks them. The elastic element 10, which includes for example one or more torsion springs as illustrated in the figures, exerts on the cover 7 permanently a force for returning to the open position. Thus, when the cover 7 is in the closed position, with the lock 9 in the activated configuration, and said lock 9 switches to the deactivated configuration, the cover 7 is automatically returned, under the effect of the force exerted by the elastic element 10, in the open position.

The use of means exerting a return force on the cover 7 is however completely optional. Thus, in the absence of elastic element 10 exerting on the cover 7 a force for returning to the open position, the passage of the lock 9 from its activated configuration to its deactivated configuration, while the cover 7 is in the closed position, will not lead to the spontaneous passage of the cover 7 into the open position. It will then be appropriate for the user to manually move the cover 7 from its closed position to its open position.

The lock 9 comprises for example a rotary latch 9A embedded on the cover 7 and mounted to rotate relative to the latter between:
a locking position, in which said latch 9A is designed to insert into a complementary cavity 9B provided in the lateral wall 20B of the main body 20, and
an unlocking position in which the latch 9A is released from the complementary cavity 9B.

The lock 9 thus forms in this case a mechanical catch. The invention is however not limited to the implementation of a lock 9 formed by such a catch, and the use of an electrical, electromechanical, or magnetic device is perfectly possible without departing from the scope of the invention. In the case of a mechanical lock, the use of a pivoting latch is also not obligatory. Thus, as illustrated in FIGS. 7 to 9, and as will be described in more detail in the following, it is alternatively possible to implement, as a lock 9, a system based on one or more stationary hooks 16 (but preferably elastically deformable) carried by the cover 7 and intended to hang on to a detachable retaining pin 14 secured to the main body 20.

Advantageously, the device 1 comprises a member 11 for controlling the lock 9 to control the passage of the lock 9 from its activated configuration to its deactivated configuration. For example, in accordance with the embodiments of FIGS. 1 to 6, the control member 11 comprises a manually actuatable portion 12 to manually control the passage of the lock 9 from its activated configuration to its deactivated configuration. For example, the manually actuatable portion 12 is in the form of a rotary button which directly rotates the latch 9A and thus allows the user to directly control the pivoting of the latch 9A.

Thus, in the event of an emergency, it is sufficient to turn the button forming the manually actuatable portion 12 to unlock the cover 7, which can then open automatically under the effect of the return force exerted by the elastic element 10 or under the effect of a manual opening force exerted by the user, possibly via the manually actuatable portion 12 which can serve as a gripping member.

Alternatively, or in addition, the control member 11 comprises a shock-sensitive element to 13 connected to the lock 9, or forming part of the latter, to automatically pass the lock 9 from its activated configuration to its deactivated configuration when the case 2 suffers a shock, and more precisely a shock characteristic of an accidental event. In this embodiment, an example of which is illustrated in FIGS. 7 to 9, it is not necessary to take a positive step to open the cover 7 and thus access to the grip and/or bearing area function provided by the latter. On the contrary, in this embodiment, the device 1 is designed to detect by itself the situations in which the opening of the cover 7 is required, in order to automatically cause the cover 7 to pass into the open position. Such emergency situations are generally associated, particularly in the case where the vehicle is an aircraft, with one or more violent shocks, linked for example to an impact of the vehicle against the ground or against a body of water. The control member 11 is in this case advantageously capable of detecting the shock in question, to in response immediately and automatically pass the lock 9 from its activated configuration to its deactivated configuration, thus releasing the cover 7 which can spontaneously reach its open position under the effect for example of the return force exerted by the elastic element 10.

For example, the shock-sensitive element 13 is an acceleration-sensitive element, capable of passing from a first state to a second state when subjected to an acceleration of a predetermined level in one or more predetermined directions.

For example, the shock-sensitive element 13 comprises on the one hand a first piece 14 connected to, or forming part of, the lock 9 and on the other hand a connection device 15 ensuring between said first piece 14 and main body 20 a rigid connection (that is to say an immobilization connection) designed to break under the effect of a predetermined displacement of said first piece 14 relative to the main body 20. In other words, the connection device 15 immobilizes (rigid connection) the first piece 14 relative to the main body 20 as long as the first piece 14 has not been subjected to a predetermined acceleration, corresponding to a shock.

For example, and as already mentioned in the above, the lock 9 advantageously comprises at least one hook 16 secured to the cover 7 and which rises to the right of the internal face 7A of the latter on the one hand, and a retaining pin which forms the first piece 14 and is attached in a predetermined position to the case 20, for example to the internal face of the bottom 20A as illustrated in the figures. In the closed position, with the cover 7 folded over the main body 20 to shut off the access opening, said at least one hook 16 is gripped to the retaining pin forming the first piece 14, as illustrated in FIG. 9. Under the effect of a shock of a predetermined nature (amplitude and direction), the first piece 14 moves and leaves its predetermined position, which results in the concomitant breakage of the rigid connection previously provided by the connection device 15. The cover 7 is therefore no longer maintained by the lock 9 in the closed position, and it can open, possibly spontaneously under the effect of a return force exerted for example by an elastic element 10, to reach its open position which makes it usable as a grip and/or bearing area.

Preferably, breaking the rigid connection provided by the connection device 15 leads to completely releasing the first piece 14 so that it can disengage from the hook 16. In order, however, to prevent the first piece 14 from being able to be transformed into projectile dangerous for the vehicle and its occupants, the device 1 advantageously comprises a flexible safety link 15A, formed for example by a cable (preferably waterproof), which permanently connects the first piece 14 to the main body 20, including when the rigid connection is broken.

In the exemplary embodiment illustrated in the figures, the connection device 15 comprises at least one first bolt 17A mounted movably between a deployed elastic return position (illustrated in FIG. 8) and a retracted position. The first bolt 17A is for example formed by a sliding finger subject to the influence of a first spring 18A which permanently returns it to its deployed position. The connection device 15 also advantageously comprises a first striker 19A, preferably formed by a cavity or concavity or groove, in which the first bolt 17A engages in the deployed position, to thus ensure said rigid connection between said first piece 14 and main body 20. More precisely, in the example illustrated in the figures, the retaining pin forming the first piece 14 extends longitudinally between first and second ends. Said first end carries the first striker 19A, which cooperates with the first bolt 17A. To this end, the connection device 15 comprises a first flange 150 which projects from the bottom 20A inside the case 2, in the interior volume V.

The first flange 150 advantageously supports an elastic connecting block which includes the first spring 18A and the first bolt 17A. The first striker 19A is positioned facing the first bolt 17A to allow the mechanical engagement of the latter within it and thus achieve said rigid connection.

Advantageously, a second striker 19B is provided at the other end of the retaining pin forming the first piece 14, as well as a second flange 151 which carries a second elastic connecting block embedding a second spring 18B which returns into the deployed position a second bolt 17B. The first piece 14 is thus maintained between the two flanges 150, 151 by elastic connecting blocks which ensure the establishment of said rigid connection between said first piece 14 and main body 20.

Advantageously, the first bolt 17A, respectively the second bolt 17B, is designed to be pushed back into the retracted position under the effect of said predetermined displacement of said first piece 14 relative to said main body 20, by a cam effect exerted by the edges of the first striker 19A, respectively the second striker 19B, so as to disengage from said first striker 19A, respectively said second striker 19B, and thus break said rigid connection. Said predetermined displacement occurs in response to an acceleration whose value exceeds a predetermined threshold value in a predetermined direction, characterizing a shock. Breaking the rigid connection results in the unlocking of the cover 7 and its passage into the open position, under the effect of the return advantageously exerted by the elastic element 10.

This embodiment is particularly advantageous because it allows automatic triggering of the opening of the cover 7 when an accident situation occurs, thanks to using extremely simple, reliable and robust means that do not require any power supply or complex maintenance operation.

In order to calibrate the rupture of the rigid connection carried out by the connection device 15 between the first piece 14 and the main body 20, it is of course appropriate to play in particular on the dimensioning and the stiffness of each spring 18A, 18B but also on the mass of the first piece 14, which is therefore provided with one or more weight(s) 14A, 14B of predetermined mass.

The invention is of course not limited to the exemplary embodiment illustrated in the figures. It is for example alternatively possible that said rigid connection provided by the connection device 15 between said first piece 14 and main body 20 is a magnetic connection. In this case, each end of the retaining pin advantageously forming the first piece 14 is for example provided with a magnet which is attached by magnetic attraction to the corresponding flange 150, 151.

According to yet another alternative, the connection device 15 comprises for example at least one breakable piece which ensures said rigid connection between said first piece 14 and main body 20. Said breakable piece connects for example one end of the retaining pin advantageously forming the first piece 14 with the corresponding flanges 150, 151. Said breakable piece is designed to break under the effect of the predetermined displacement of said first piece 14 relative to the main body 20, so as to thus break said rigid connection.

The various alternative solutions disclosed in the above all have the major advantage of not requiring electrical power sources, and of relying on extremely simple and passive mechanical or magnetic mechanisms. It is however perfectly possible, without departing from the scope of the invention, to implement a shock-sensitive element 13 which comprises electrical, electronic or electromagnetic means, with where appropriate electrically powered sensors.

Preferably, the device 1 for assisting the emergency evacuation of a vehicle according to the invention includes, disposed in said interior volume V, one or more of the following devices:
A flexible unwindable ladder 60. Preferably, the flexible ladder 60 is designed to unwind automatically as soon as the cover 7 is opened, and thus makes it possible to facilitate the access of an individual to the bearing area formed by the cover 7.
A handle 61 stationary or articulated to the main body 20. For example, the handle 61 is pivotally mounted relative to the main body 20 along an axis of rotation parallel to the axis of rotation X-X′ of the cover 7. The handle 61 can advantageously evolve between a retracted position (illustrated in FIGS. 2 and 6) and a deployed position which it reaches after an angular travel of 90° bringing it perpendicular to the bottom 2A. Preferably, the deployed position is an elastic return position, to make the handle 61 immediately accessible and practical to use as soon as the cover 7 passes into the open position. The handle 61 thus acts as a grip or additional bearing point to facilitate evacuation, in combination with the bearing and grip surface provided by the cover 7 itself.
A hook 62, which can for example be used to hang emergency equipment.
A ring 63, which can serve as an attachment, hanging or gripping point (for example to hold on manually) in order to facilitate the evacuation operation, in combination with the bearing area formed by the cover 7.
A respirator mask (not illustrated), to allow for example an individual to be able to breathe correctly in the event of a fire, if the area where it is located is invaded by smoke. Such a respirator mask can also be used, when the vehicle is a marine or underwater vehicle, to allow breathing underwater if the area where the individual concerned is located is drowned, or if the evacuation exit emerges into a submerged area.
A supplementary respiratory block (not illustrated), which includes a supplementary bottle containing a respiratory gas (air, oxygen) as well as a regulator, to allow underwater evacuation.

In this advantageous embodiment, the device 1 thus assumes, in addition to its function of providing in the event of an emergency, a bearing area and/or a grip allowing a person to hoist themselves towards an evacuation exit of the vehicle, a function of providing equipment likely to facilitate the evacuation and/or survival of individuals present in the accident vehicle.

Of course, the above list is absolutely not exhaustive and it may well be possible for other equipment to be disposed within the interior volume V, whether it is emergency, signaling equipment or any other equipment useful or not for evacuation or survival.

Preferably, retro-reflective signaling 500 and/or photoluminescent 600 devices are disposed in the interior volume V, to be visible once the cover 7 is in the open position, in order to facilitate the evacuation operations and survival. The retro-reflective signaling 500 and/or photoluminescent 600 devices can for example clad a stationary surface inside the main body 20 as illustrated in FIG. 5 and/or clad one or more of the equipment (handle 61 for example) present in the interior volume V. A procedure for recharging the photoluminescent devices 600 may consist, prior to any displacement of the vehicle, in opening the cover 7 to expose the photoluminescent devices 600 to a light source for a predetermined duration.

The invention concerns, according to another aspect, a liquid retention device 50 intended to be embedded on the interior floor of the vehicle, which is preferably a rescue or evacuation helicopter. The liquid retention device 50 is designed and configured to collect equipment (not illustrated) embedded in said vehicle, for example a seat or a stretcher, in particular during a rescue operation. Such a rescue mission includes, for example, an operation of recovering an individual in a body of water, particularly at sea (including on a ship). The embedded equipment comprises, for example, a stretcher, but it may alternatively be a passenger seat of the vehicle, or any other equipment. The dimensions of the liquid retention device 50 are preferably adapted to support all of the embedded equipment, that is to say that the retention device 50 is configured to be interposed between the interior floor of the vehicle and the embedded equipment. According to a particular embodiment, the embedded equipment comprises a stretcher, which has for example been immersed during an operation of recovering an individual at sea. The individual is therefore placed on the stretcher, which is then transported (for example helicoptered) within the vehicle, which is for example a helicopter. In this last particular case or in other situations, liquid (water in this case) is likely to flow from the stretcher and the rescued individual. The liquid retention device 50 is thus advantageously designed to capture and retain the liquid which spills from the wet stretcher in particular and/or from any other wet equipment during the marine recovery operation.

To this end, the liquid retention device 50 comprises at least one upper wall 51 designed and configured to support said embedded equipment, said upper wall 51 being provided with a plurality of through holes 52. The retention device 50 also comprises a liquid storage tank 53 arranged at least partly below said upper wall 51 to collect liquid passing through said through holes 52.

Said upper wall 51 is thus advantageously intended to receive the entire weight of said embedded equipment, in particular the entire weight of a stretcher, possibly wet with sea water. Said upper wall 51 advantageously has a generally flat surface, which forms thus a false floor disposed above the interior floor of the vehicle. The upper wall 51 is formed for example by at least one plate. The through holes 52 are provided throughout the entire thickness of said plate and are advantageously distributed regularly over all or part of the surface of the upper wall 51. The liquid storage tank 53 advantageously forms a tray, which preferably has its own mechanical strength, said tray being closed at its upper opening by the upper wall 51.

Advantageously, a housing is provided in said upper wall 51. Said housing is for example in the form of a cavity provided at least on the surface of the upper wall 51. According to the embodiment illustrated in FIG. 10, the liquid retention device 50 also comprises at least one device 1 for assisting the emergency evacuation of a vehicle in accordance with the invention and the preceding description. The case 2 of said device 1 is disposed within said housing provided in the upper wall 51, preferably in such a way that the cover 7, in the closed position (FIG. 10), is flush with the upper wall 51 which surrounds it, that is to say that the cover 7 advantageously extends in the same plane as the upper wall 51.

Advantageously, in this embodiment, the emergency evacuation assistance device 1 comprises a seal disposed between the main body 20 and the cover 7, so that when the cover 7 is in the closed position, the liquid which may possibly spill onto the liquid retention device 50 cannot penetrate the interior volume V.

Advantageously and as illustrated in the figures, the emergency evacuation assistance device 1 which equips the liquid retention device 50 is attached directly to the interior floor of the vehicle, which interior floor forms in this case said wall 5 on which rests the tray forming the liquid storage tank 53. In this case, said housing provided in the upper wall 51 advantageously forms a well which passes through the tray and allows the fastening member 3 to come attached to the (preferably interior) wall 5 which forms the floor, for example through an aeronautical rail fastened to said wall 5 or integrated into the latter according to the principle illustrated in FIG. 4.

Alternatively, it is however perfectly conceivable that the emergency evacuation assistance device 1 is simply attached to the upper wall 51 and/or to the liquid storage tank 53, the latter being attached to the wall 5. In this alternative embodiment, the emergency evacuation assistance device 1 fitted to the liquid retention device 50 is therefore secured indirectly to the wall 5, through the upper wall 51 and/or or the liquid storage tank 53.

The liquid retention device 50 thus makes it possible to provide an emergency evacuation assistance function by providing a bearing area and/or a grip formed by the cover 7 in the open position, in the event of an accident situation with for example an immobilization of the vehicle on one of its sides causing the verticalization of the floor forming the wall 5.

Generally, beyond the example disclosed in the above concerning a liquid retention device 50, the invention also independently concerns a system comprising a false floor intended to cover the interior floor of a vehicle as well as an emergency evacuation assistance device 1 conforming to the preceding description and which is integrated into the thickness of this false floor, to be flush with the surface of the latter.

Finally, the invention also generally concerns, as mentioned previously, a vehicle, and in particular a vehicle which is one of those mentioned above (including a helicopter), comprising a wall 5 as well as an emergency evacuation assistance device 1 in accordance with the preceding description, in which said emergency evacuation assistance device 1 is secured to said wall 5 by means of said fastening member 3, 4, in a direct (FIG. 4) or indirect (for example by being fastened to equipment, such as a liquid retention device 50, itself fastened to the wall 5, which is preferably an interior wall) manner.

### POSSIBILITY OF INDUSTRIAL APPLICATION

The invention finds its industrial application in the design, manufacture and use of survival assistance equipment and vehicles and devices equipped with it.

1. A vehicle comprising:
an interior wall (5), which forms for example an interior wall of cabin or cockpit,
an evacuation exit of the vehicle,
and a device (1) for assisting the emergency evacuation of the vehicle which is secured to said wall (5) by means of at least one fastening member (3, 4),
said device (1) comprising a case (2), said case (2) comprising a main body (20) delimiting an interior volume (V) as well as at least one cover (7) connected to said main body (20) by a permanent connection means (8) which allows the cover (7) to move relative to said main body (20) between a closed position in which said cover (7) closes access to said interior volume (V) and an open position in which said cover (7) frees access to said interior volume (V) while projecting from said main body (20), said main body (20), fastening member (3, 4), cover (7) and permanent connection means (8) being shaped and dimensioned so that the cover (7) contributes to forming, in the open position, a bearing area and/or a grip allowing a person to hoist themselves towards said evacuation exit by leaning on, and/or grabbing, said cover (7).

2. The vehicle according to the preceding claim characterized in that said fastening member (3, 4) reversibly secures said device (1) to said wall (5).

3. The vehicle according to claim 1 characterized in that said cover (7) is articulated to said main body (20), said permanent connection means (8) including at least one hinge (80) connecting said main body (20) and cover (7).

4. The vehicle according to claim 1 characterized in that said permanent connection means (8) includes at least one means (81) for maintaining said cover (7) in the open position.

5. The vehicle according to claim 1 characterized in that said case (2) comprises a lock (9) capable of alternatively adopting an activated configuration, in which it is designed to maintain said cover (7) in the closed position, and a deactivated configuration, in which it is designed to allow the cover (7) to pass into the open position.

6. The vehicle according to the preceding claim characterized in that it comprises a member (11) for controlling the lock (9) to control the passage of the lock (9) from its activated configuration to its deactivated configuration.

7. The vehicle according to the preceding claim characterized in that said control member (11) comprises a manually actuatable portion (12) for manually controlling the passage of the lock (9) from its activated configuration to its deactivated configuration.

8. The vehicle according to claim 6 characterized in that said control member (11) comprises a shock-sensitive element (13) connected to the lock (9), or forming part of the latter, to automatically pass the lock (9) from its activated configuration to its deactivated configuration when the case (2) is subjected to a shock.

9. The vehicle according to the preceding claim characterized in that said shock-sensitive element (13) comprises on the one hand a first piece (14) connected to, or forming part of, the lock (9) and on the other hand a connection device (15) ensuring between said first piece (14) and main body (20) a rigid connection designed to break under the effect of a predetermined displacement of said first piece (14) relative to said main body (20).

10. The vehicle according to the preceding claim characterized in that said rigid connection provided by the connection device between said first piece (14) and main body (20) is a magnetic connection.

11. The vehicle according to claim 9 characterized in that the connection device (15) comprises at least one first bolt (17A) mounted movably between a deployed elastic return position and a retracted position, as well as a first striker (19A) in which the first bolt (17A) engages in the deployed position to thus ensure said rigid connection between said first piece (14) and main body (20), said first bolt (17A) being designed to be pushed back into the retracted position under the effect of said predetermined displacement of said first piece (14) relative to said main body (20) so as to disengage from said first striker (19A) and thus break said rigid connection.

12. The vehicle according to claim 9 characterized in that the connection device (15) comprises at least one breakable piece which ensures said rigid connection between said first piece (14) and main body (20), said breakable piece being designed to be break under the effect of said predetermined displacement of said first piece (14) relative to said main body (20), so as to thus break said rigid connection.

13. The vehicle according to claim 1 characterized in that said case (2) includes at least one elastic element (10) which exerts on said cover (7) a force for returning to the open position.

14. The vehicle according to claim 1 characterized in that said cover (7) has at least one first surface (S1), while said main body (20) has at least one second surface (S2) located in said interior volume (V), said first surface (S1) being positioned substantially in continuity with said second surface (S2) when the cover (7) is in the open position.

15. The vehicle according to claim 1 characterized in that said main body (20) comprises a bottom (20A) as well as a lateral wall (20B) which rises from said bottom (20A) between a lower edge secured to the bottom (20A) and a free upper edge (200) which defines an opening providing access to said interior volume (V), said cover (7) being designed to, in the closed position, extend in a first plane substantially perpendicular to said lateral wall (20B) to shut off said access opening, and to, in the open position, extend in a second plane substantially perpendicular to said first plane.

16. The vehicle according to claim 1 characterized in that said device (1) for assisting the emergency evacuation of the vehicle includes, disposed in said interior volume (V), one or more of the following devices:
a flexible unwindable ladder (60),
a handle (61) stationary or articulated to the main body (20),
a hook (62),
a ring (63),
a respirator mask,
a supplementary respiratory block.

17. The vehicle according to claim 1 characterized in that it is part of at least one of the following groups:
flying vehicles, including aerostats and aerodynes with stationary or rotary wings,
marine or underwater vehicles.

18. A liquid retention device (50) intended to be embedded on the interior floor of a vehicle according to any one of the preceding claims, said liquid retention device (50) being designed and configured to collect equipment embedded in said vehicle, for example a seat or a stretcher, the retention device (50) comprising at least:
an upper wall (51) designed and configured to support said equipment, said upper wall (51) being provided with a plurality of through holes (52),
a liquid storage tank (53) arranged at least partly below said upper wall (51) to collect liquid passing through said through holes (52),
a housing provided in said upper wall (51),
said case (2) being disposed within said housing.

19. A device (1) for assisting the emergency evacuation of a vehicle comprising a case (2) provided with at least one fastening member (3, 4) for reversibly securing said case (2) to a wall (5) of said vehicle, said case (2) comprising a main body (20) delimiting an interior volume (V) as well as at least one cover (7) connected to said main body (20) by a permanent connection means (8) which allows the cover (7) to move relative to said main body (20) between a closed position in which said cover (7) closes access to said interior volume (V) and an open position in which said cover (7) frees access to said interior volume (V) while projecting from said main body (20), said main body (20), fastening member (3, 4), cover (7) and permanent connection means (8) being shaped and dimensioned so that the cover (7) contributes to forming, in the open position, a bearing area and/or a grip allowing a person to hoist themselves towards an exit evacuation of the vehicle by leaning on, and/or grabbing, said cover (7), said device (1) including, disposed in said interior volume (V), one or more of the following devices:
a flexible unwindable ladder (60),
a handle (61) stationary or articulated to the main body (20),
a hook (62),
a ring (63),
a respirator mask,
a supplementary respiratory block.

20. The device (1) for assisting the emergency evacuation of a vehicle according to the preceding claim characterized in that said cover (7) is articulated to said main body (20), said permanent connection means (8) including at least one hinge (80) connecting said main body (20) and cover (7).

21. The device (1) for assisting the emergency evacuation of a vehicle according to claim 19 characterized in that said permanent connection means (8) includes at least one means (81) for maintaining in the open position said cover (7).

22. The device (1) for assisting the emergency evacuation of a vehicle according to claim 19 characterized in that said case (2) comprises a lock (9) capable of adopting alternately an activated configuration, in which it is designed to maintain said cover (7) in the closed position, and a deactivated configuration, in which it is designed to allow the cover (7) to pass into the open position.

23. The device (1) for assisting the emergency evacuation of a vehicle according to the preceding claim characterized in that it comprises a member (11) for controlling the lock (9) to control the passage of the lock (9) from its activated configuration to its disactivated configuration.

24. The device (1) for assisting the emergency evacuation of a vehicle according to the preceding claim characterized in that said control member (11) comprises a manually actuatable portion (12) for manually controlling the passage of the lock (9) from its activated configuration to its disactivated configuration.

25. The device (1) for assisting the emergency evacuation of a vehicle according to claim 23 characterized in that said control member (11) comprises a shock-sensitive element (13) connected to the lock (9), or forming part of the latter, to automatically pass the lock (9) from its activated configuration to its deactivated configuration when the case (2) is subjected to a shock.

26. The device (1) for assisting the emergency evacuation of a vehicle according to the preceding claim characterized in that said shock-sensitive element (13) comprises on the one hand a first piece (14) connected to, or forming part of, the lock (9) and on the other hand a connection device (15) ensuring between said first piece (14) and main body (20) a rigid connection designed to break under the effect of a predetermined displacement of said first piece (14) relative to said main body (20).

27. The device (1) for assisting the emergency evacuation of a vehicle according to the preceding claim characterized in that said rigid connection provided by the connection device between said first piece (14) and main body (20) is a magnetic connection.

28. The device (1) for assisting the emergency evacuation of a vehicle according to claim 26 characterized in that the connection device (15) comprises at least one first bolt (17A) mounted movably between a deployed elastic return position and a retracted position, as well as a first striker (19A) in which the first bolt (17A) engages in the deployed position to thus ensure said rigid connection between said first piece (14) and main body (20), said first bolt (17A) being designed to be pushed back into the retracted position under the effect of said predetermined displacement of said first piece (14) relative to said main body (20) so as to disengage from said first striker (19A) and thus break said rigid connection.

29. The device (1) for assisting the emergency evacuation of a vehicle according to claim 26 characterized in that the connection device (15) comprises at least one breakable piece which ensures said rigid connection between said first piece (14) and main body (20), said breakable piece being designed to break under the effect of said predetermined displacement of said first piece (14) relative to said main body (20), so as to thus break said rigid connection.

30. The device (1) for assisting the emergency evacuation of a vehicle according to claim 19 characterized in that said case (2) includes at least one elastic element (10) which exerts on said cover (7) a force for returning to the open position.

31. The device (1) for assisting the emergency evacuation of a vehicle according to claim 19, characterized in that said cover (7) has at least one first surface (S1), while said main body (20) has at least one second surface (S2) located in said interior volume (V), said first surface (S1) being positioned substantially in continuity with said second surface (S2) when the cover (7) is in the open position.

32. The device (1) for assisting the emergency evacuation of a vehicle according to claim 19 characterized in that said main body (20) comprises a bottom (20A) as well as a lateral wall (20B) which rises from said bottom (20A) between a lower edge secured to the bottom (20A) and a free upper edge (200) which defines an opening providing access to said interior volume (V), said cover (7) being designed to, in the closed position, extend in a first plane substantially perpendicular to said lateral wall (20B) to shut off said access opening, and to, in the open position, extend in a second plane substantially perpendicular to said first plane.
